(19) United States
(12) Patent Application Publication
(10) Pub. No.: US 2008/0129268 A1
(43) Pub. Date: Jun. 5, 2008

(54) Dual Voltage Power Supply

(76) Inventor: Alan D. DeVilbiss, Colorado Springs, CO (US)

Correspondence Address: HANES & SCHUTZ, LLC, 102 SOUTH TEJON ST., SUITE 800, COLORADO SPRINGS, CO, 80903, US

(21) Appl. No.: 11/564,989

(22) Filed: Nov. 30, 2006

(51) Int. Cl. G05F 1/10; H02J 7/00

(52) U.S. Cl. 323/288; 323/282; 320/166

(57) ABSTRACT

A power supply for an integrated circuit has first and second energy storage elements and a regulator. The first energy storage element stores energy for application to the integrated circuit. The second energy storage element stores energy at a higher voltage than the energy stored by the first energy storage element. The regulator interconnects the energy storage elements and controls the flow of energy from the second energy storage element to the first energy storage element to regulate the voltage level of the energy stored in the first energy storage element.

### BACKGROUND OF THE INVENTION

Radio frequency identification (RFID) chips typically include circuitry that rectifies a carrier wave to generate a regulated power supply for the chip. The carrier wave is generated by a RFID chip reader. The further the reader is from the RFID chip, the weaker the carrier wave is when it reaches the RFID chip. Consequently, the further the reader is from the RFID chip, the lower the voltage and the amount of power available to the chip from the rectified carrier wave. In order to achieve the longest possible read distance, RFID chips are designed to operate at the lowest possible voltage. Operating at a low voltage also reduces the power consumption of the chip since power consumption on the chip is directly related to the operating voltage.

### DESCRIPTION OF THE DRAWINGS

FIG. 1 is block diagram of one embodiment of the present invention dual voltage power supply.

FIG. 2 is circuit diagram of one embodiment of the present invention dual voltage power supply.

FIG. 3 is a flow cart illustrating one embodiment of the present invention method for supplying power.

### DETAILED DESCRIPTION OF THE INVENTION

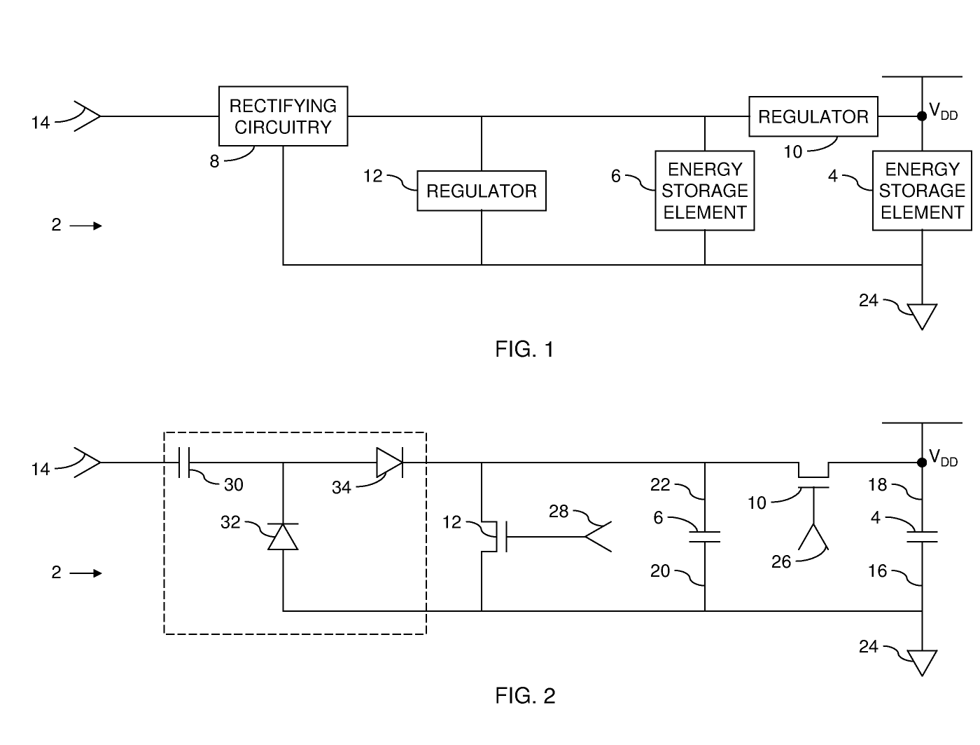

FIG. 1 is a block diagram illustrating one embodiment of a power supply 2 for an integrated circuit. In this embodiment, power supply 2 includes first energy storage element 4, second energy storage element 6, rectifying circuitry 8, series regulator 10, and shunt regulator 12.

First energy storage element 4 stores energy for application to the integrated circuit. For instance, first energy storage element 4 may store energy at around 1.2 volts for use by an integrated circuit such as a radio frequency identification (RFID) circuit. The energy stored by first energy storage element 4 may be represented by the voltage V_{DD} with respect to a ground 24 for the integrated circuit.

In one embodiment, first energy storage element 4 includes a capacitive element 4, such as single capacitor, a group of capacitors, or any other single device or group of devices that have suitable capacitive properties. Alternatively, first energy storage element 4 includes any other component or element for storing and releasing energy for application to an integrated circuit.

In one embodiment, the energy stored in energy storage element 4 is directly applied to and powers the integrated circuit. In alternate embodiments, the energy stored in energy storage element 4 powers the integrated circuit, but is applied to the integrated circuit through intervening elements, consistent with the operation of the integrated circuit.

Second energy storage element 6 stores energy at a higher voltage than the energy stored by first energy storage element 4. For instance, second energy storage element 6 may store energy at about 4 to 5 volts. Alternatively, second energy storage element 6 may store energy at any multiple of the voltage level of the energy stored in first energy storage element 4, such as one and a half times or two times the voltage level of the energy stored in first energy storage element 4.

In one embodiment, second energy storage element 6 includes a capacitive element 6, such as single capacitor, a group of capacitors, or any other single device or group of devices that have suitable capacitive properties. Alternatively, second energy storage element 6 includes any other component or element for storing and releasing energy at a voltage higher than the energy stored by first energy storage element 4.

Where the first and second energy storage element each include a capacitive element, the capacitance of second capacitive element 6 is greater than the capacitance of first capacitive element 4. For example, the capacitance of first capacitive element 4 is on the order of 50 picoFarads and the capacitance of second capacitive element 6 is on the order of 500 picoFarads. This allows the second capacitive, or energy storage, element 6 to store a energy at a higher voltage than the energy stored by the first capacitive, or energy storage, element 4.

An antenna 14 feeds a carrier wave signal to rectifying circuitry 8. Rectifying circuitry 8 rectifies the signal of the carrier wave to supply energy to second energy storage element 6.

Regulator 10 interconnects the first and second energy storage elements and controls the flow of energy from second energy storage element 6 to first energy storage element 4 to regulate the voltage level of the energy stored in first energy storage element 4. In one embodiment, regulator 10 includes a MOSFET series regulator 10. The current flowing through series regulator 10 is controlled to maintain a desired voltage level for first energy storage element 4.

Shunt regulator 12 regulates the voltage level for second energy storage element 6. In one embodiment, shunt regulator 12 is a MOSFET shunt regulator operated to maintain a desired voltage level across second energy storage element 6.

Any combination of first 4 and second 6 energy storage elements, rectifying circuitry 8, series regulator 10, and shunt regulator 12 may be embodied within the integrated circuit. Additionally, any combination of first 4 and second 6 energy storage elements, rectifying circuitry 8, series regulator 10, and shunt regulator 12 may be embodied with the integrated circuit on a chip.

FIG. 2 is a block diagram illustrating one embodiment of a power supply 2 for an integrated circuit. Elements in FIG. 2 that are like the elements in FIG. 1 are given the same reference number as in FIG. 1. In the embodiment of FIG. 2, power supply 2 includes first capacitive element 4 and second capacitive element 6, rectifying circuitry 8, series regulators 10, and shunt regulator 12.

First capacitive element 4 and second capacitive element 6 are elements of the integrated circuit having capacitance, such as single capacitor, a group of capacitors, or any other single device or group of devices that have suitable capacitive properties. First capacitive element 4 and second capacitive element 6 are arranged in parallel with one another.

In one embodiment, second capacitive element 6 has a greater capacitance than first capacitive element 4. For example, the capacitance of first capacitive element 4 is on the order of 50 picoFarads and the capacitance of second capacitive element 6 is on the order of 500 picoFarads. This allows the second capacitive element 6 to store energy at a higher voltage than the energy stored by the first capacitive element 4.

Each of first 4 and second 6 capacitive elements has first 16, 20 and second 18, 22 terminals. First terminals 16, 20 of first 4 and second 6 capacitive elements are interconnected with circuit ground 24. Second terminal 18 of first capacitive element 4 is applied to the integrated circuit for providing power to the integrated circuit. The power provided to the integrated circuit may be represented by the voltage V_{DD} with respect to a ground 24 for the integrated circuit.

Antenna 14 feeds a carrier wave signal to rectifying circuitry 8. Rectifying circuitry 8 rectifies the signal of the carrier wave to supply energy to second energy storage element 6. In the embodiment illustrated in FIG. 2, rectifying circuitry 8 includes a rectifying capacitive element 30, first diode element 32, and second diode element 34. Together rectifying capacitive element 30, first diode element 32, and second diode element 34 rectify the signal of the carried wave.

Series regulator 10 is interposed between second terminals 18, 22 of first 4 and second 6 capacitive elements. Series regulator 10 is operated to control the flow of energy from second capacitive element 6 to first capacitive element 4 to regulate the voltage level of the energy stored in first capacitive element 4. In one embodiment, series regulator 10 includes a MOSFET series regulator 10. The current flowing through series regulator 10 is controlled to maintain a desired voltage level for first capacitive element 4. Any type of suitable control means 26 may be used to control the gate of MOSFET series regulator 10 in order to control the current flowing through series regulator 10. For example, a feedback control means 26 using as input the voltage V_{DD} may be used to control the gate of series regulator 10.

Shunt regulator 12 regulates the voltage level of the energy stored in second capacitive element 6. Shunt regulator 12 is arranged in parallel with second capacitive element 6 for regulating the voltage level of the energy stored in second capacitive element 6. In one embodiment, shunt regulator 12 is a MOSFET shunt regulator operated to maintain a desired voltage level across second energy storage element 6.

The current flowing through shunt regulator 12 is controlled to maintain a desired voltage level for second capacitive element 6. Any type of suitable control means 28 may be used to control the gate of MOSFET shunt regulator 12 in order to control the current flowing through shunt regulator 12. For example, a feedback control means 28 using as input the voltage across second capacitive element 6 may be used to control the gate of shunt regulator 12.

Any combination of first 4 and second 6 capacitive elements, rectifying circuitry 8, series regulator 10, and shunt regulator 12 may be embodied within the integrated circuit. Additionally, any combination of first 4 and second 6 capacitive elements, rectifying circuitry 8, series regulator 10, and shunt regulator 12 may be embodied with the integrated circuit on a chip.

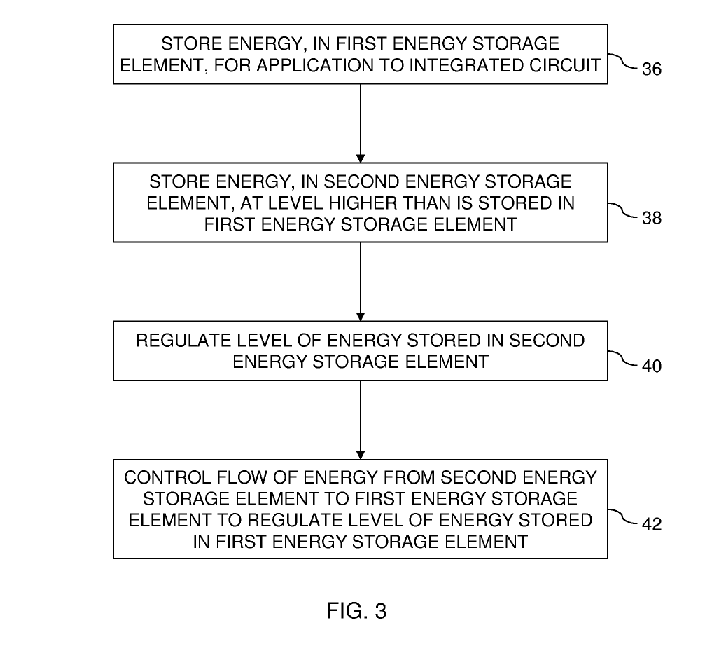

FIG. 3 is a flow chart representing steps of one embodiment of a method for supplying power to an integrated circuit. Although the steps represented in FIG. 3 are presented in a specific order, the disclosed subject matter encompasses variations in the order of steps. Furthermore, additional steps may be executed between the steps illustrated in FIG. 3 without departing from the scope of the claimed subject matter.

Energy is stored 36 for application to the integrated circuit. For instance, the stored energy may be stored at around 1.2 volts for use by an integrated circuit such as a radio frequency identification (RFID) circuit. The stored energy may be represented by the voltage V_{DD} with respect to a ground 24 for the integrated circuit. In one embodiment, the energy stored for application to the integrated circuit is stored in first energy storage element 4.

In one embodiment, the energy is stored 36 for direct application to the integrated circuit. In alternate embodiments, the energy is stored 36 for application to the integrated circuit, but is applied to the integrated circuit through intervening elements, consistent with the operation of the integrated circuit.

Energy is stored 38 at a higher voltage than the energy stored 36 in first energy storage element 4. In one embodiment, the energy stored 38 at the higher voltage is stored 38 in second energy storage element 6. In one embodiment, the energy is stored 38 at about 4 to 5 volts. Alternatively, the energy is stored 38 at any multiple of the voltage level of the energy stored in first energy storage element 4, such as one and a half times or two times the voltage level of the energy stored in first energy storage element 4.

The voltage level of the energy stored 38 in second energy storage element 6 is regulated 40. In one embodiment, the voltage level of the energy stored 38 in energy storage element 6 is regulated by shunt regulator 12.

The flow of energy is controlled 42 from second energy storage element 6 to first energy storage element 4 to regulate the voltage level of the energy stored in first energy storage element 4.

In practice, when the carrier wave signal is received by antenna 14, it is rectified by rectifying circuitry 8. The rectified carrier wave signal charges second energy storage, or capacitive, element 6 to a desired voltage level. Series regulator 10 allows current to flow to first energy storage, or capacitive, element 4. The current flow charges first energy storage, or capacitive, element 4 to a desired voltage level. The integrated circuit operates from the voltage V_{DD} across first energy storage, or capacitive, element 4. When the carrier wave signal is no longer received on the antenna, second energy storage, or capacitive, element 6 discharges to maintain the voltage level across first energy storage, or capacitive, element 4. Second energy storage, or capacitive, element 6 is able to discharge from voltage level down to the voltage level of voltage V_{DD} with little or no effect on the voltage V_{DD} across first energy storage, or capacitive, element 4.

The foregoing description is only illustrative of the invention. Various alternatives, modifications, and variances can be devised by those skilled in the art without departing from the invention. Accordingly, the present invention embraces all such alternatives, modifications, and variances that fall within the scope of the described invention.

What is claimed is:

1. A power supply for an integrated circuit, the power supply comprising:
a first energy storage element for storing energy for application to the integrated circuit;
a second energy storage element for storing energy at a higher voltage than is stored by the first energy storage element; and
a regulator interconnecting the first and second energy storage elements, the regulator controlling the flow of energy from the second energy storage element to the first energy storage element to regulate the voltage level of the energy stored in the first energy storage element.

2. The power supply of claim 1 wherein the first energy storage element stores energy for direct application to the integrated circuit.

3. The power supply of claim 1 wherein the first and second energy storage elements and the regulator are embodied within the integrated circuit.

4. The power supply of claim 1 wherein the integrated circuit, the regulator, and the first and second energy storage elements are embodied on a chip.

5. The power supply of claim 1 wherein the regulator includes a series regulator.

6. The power supply of claim 1 wherein the first energy storage element includes a capacitive element.

7. The power supply of claim 1 wherein the second energy storage element includes a capacitive element.

8. The power supply of claim 1 wherein the first and second energy storage element each include a capacitive element and the capacitance of the second capacitive element is greater than the capacitance of the first capacitive element.

9. The power supply of claim 1 further including a shunt regulator for regulating the voltage level of the energy stored in the second energy storage element.

10. The power supply of claim 1 wherein the voltage level of the energy stored in the second energy storage element is at least one and a half times the voltage level of the energy stored in the first energy storage element.

11. The power supply of claim 1 wherein the voltage level of the energy stored in the second energy storage element is at least twice the voltage level of the energy stored in the first energy storage element.

12. A method for supplying power to an integrated circuit, the method comprising:
storing energy, in a first energy storage element, for application to the integrated circuit;
storing energy, in a second energy storage element, at a higher voltage than the energy stored in the first energy storage element;
controlling the flow of energy from the second energy storage element to the first energy storage element to regulate the voltage level of the energy stored in the first energy storage element.

13. The method of claim 12 wherein storing energy for application to the integrated circuit includes storing energy for direct application to the integrated circuit.

14. The method of claim 12 further including regulating the voltage level of the energy stored in the second energy storage element.

15. The method of claim 12 wherein the voltage level of the energy stored in the second energy storage element is at least one and a half times the voltage level of the energy stored in the first energy storage element.

16. The method of claim 12 wherein the voltage level of the energy stored in the second energy storage element is at least twice the voltage level of the energy stored in the first energy storage element.

17. A power supply for an integrated circuit having a circuit ground, the power supply including:
first and second capacitive elements in parallel, the second capacitive element having a greater capacitance than the first capacitive element, each of the first and second capacitive elements having first and second terminals, the first terminal of each of the first and second capacitive elements interconnected with the circuit ground, the second terminal of the first capacitive element applied to the integrated circuit for providing power to the integrated circuit;
a series regulator interposed between the second terminals of the first and second capacitive elements, the series regulator operated to control the flow of energy from the second capacitive element to the first capacitive element to regulate the voltage level of the energy stored in the first capacitive element.

18. The power supply of claim 17 wherein the first and second capacitive elements and the series regulator are embodied within the integrated circuit.

19. The power supply of claim 17 wherein the integrated circuit, the series regulator, and the first and second capacitive elements are embodied on a chip.

20. The power supply of claim 17 further including a shunt regulator in parallel with the second capacitive element for regulating the voltage level of the energy stored in the second capacitive element.

21. The power supply of claim 17 wherein the voltage level of the energy stored in the second capacitive element is at least one and a half times the voltage level of the energy stored in the first capacitive element.

22. The power supply of claim 17 wherein the voltage level of the energy stored in the second capacitive element is at least twice the voltage level of the energy stored in the first capacitive element.

23. A power supply for a radio frequency identification (RFID) circuit, the power supply comprising:
an antenna for receiving a carrier wave signal from an RFID reader;
rectifying circuitry for rectifying the carrier wave signal;
a first energy storage element, charged by the rectified carrier wave, for storing energy, at an operating voltage, for application to the integrated circuit;
a second energy storage element, charged by the rectified carrier wave, for storing energy at a higher voltage than the operating voltage; and
a regulator interconnecting the first and second energy storage elements, the regulator controlling the flow of energy from the second energy storage element to the first energy storage element to regulate the voltage level of the energy stored in the first energy storage element when the strength of the rectified carrier wave is inadequate to charge the first energy storage element to the operating voltage.

24. The power supply of claim 23 wherein the first energy storage element stores energy for direct application to the RFID circuit.

25. The power supply of claim 23 wherein the first and second energy storage elements and the regulator are embodied within the RFID circuit.

26. The power supply of claim 23 wherein the RFID circuit, the regulator, and the first and second energy storage elements are embodied on a chip.

27. The power supply of claim 23 wherein the regulator includes a series regulator.

28. The power supply of claim 23 wherein the first energy storage element includes a capacitive element.

29. The power supply of claim 23 wherein the second energy storage element includes a capacitive element.

30. The power supply of claim 23 wherein the first and second energy storage element each include a capacitive element and the capacitance of the second capacitive element is greater than the capacitance of the first capacitive element.

31. The power supply of claim 23 further including a shunt regulator for regulating the voltage level of the energy stored in the second energy storage element.

32. The power supply of claim 23 wherein the voltage level of the energy stored in the second energy storage element is at least one and a half times the voltage level of the energy stored in the first energy storage element.

33. The power supply of claim 23 wherein the voltage level of the energy stored in the second energy storage element is at least twice the voltage level of the energy stored in the first energy storage element.
